(19) United States
(12) Patent Application Publication
(10) Pub. No.: US 2024/0019866 A1
(43) Pub. Date: Jan. 18, 2024

(54) AERIAL VEHICLE CONTROL METHOD AND APPARATUS, AERIAL VEHICLE, AND STORAGE MEDIUM

(71) Applicant: SZ DJI TECHNOLOGY CO., LTD., Shenzhen (CN)

(72) Inventors: Jie QIAN, Shenzhen (CN); Xiaodong GUO, Shenzhen (CN)

(21) Appl. No.: 18/475,536

(22) Filed: Sep. 27, 2023

Related U.S. Application Data
(63) Continuation of application No. PCT/CN2021/084885, filed on Apr. 1, 2021.

(51) Int. Cl. G05D 1/00; G05D 1/12; G05D 1/10

(52) U.S. Cl. CPC G05D 1/0094; G05D 1/12; G05D 1/106

(57) ABSTRACT

A control method includes generating a flight route for an aerial vehicle based on position information of a first target, and in response to detecting a change in a relative orientation between a second target and the aerial vehicle, controlling a sensor of the aerial vehicle to continuously track the second target according to position information of the second target.

### CROSS-REFERENCE TO RELATED APPLICATION

This application is a continuation of International Application No. PCT/CN2021/084885, filed Apr. 1, 2021, the entire content of which is incorporated herein by reference.

### TECHNICAL FIELD

The present disclosure relates to the aerial vehicle technology field and, more particularly, to an aerial vehicle control method, a control apparatus, an aerial vehicle, and a storage medium.

### BACKGROUND

With the development of the technology, aerial vehicles, such as unmanned aerial vehicles (UAVs), are widely used. For example, aerial vehicles are widely used in aerial photography, surveying scenes, monitoring scenes, navigation scenes, etc. In the above scenario, an aerial vehicle needs to detect or track a target. An aerial vehicle carrying an effective payload (e.g., a camera) is used to track the target or move toward the target. To implement the above function, the same target is used to automatically control components of the aerial vehicle to be cooperatively operate, which provides limited real-time automatic control ability.

### SUMMARY

In accordance with the disclosure, there is provided a control method. The method includes generating a flight route for an aerial vehicle based on position information of a first target, and in response to detecting a change in a relative orientation between a second target and the aerial vehicle, controlling a sensor of the aerial vehicle to continuously track the second target according to position information of the second target.

Also in accordance with the disclosure, there is provided a control apparatus, including one or more processors and one or more memories. The one or more memories store one or more executable instructions that, when executed by the one or more processors, to causes the one or more processors to generate a flight route for an aerial vehicle with a sensor according to position information of a first target, and in response to detecting a change in a relative orientation between a second target and the aerial vehicle, control the sensor to continuously track a second target according to position information of the second target.

### BRIEF DESCRIPTION OF THE DRAWINGS

FIG. 1 is a schematic structural diagram of an aerial flight system consistent with an embodiment of the present disclosure.

FIG. 2 is a schematic diagram of an application scenario consistent with an embodiment of the present disclosure.

FIG. 3 is a schematic flowchart of an aerial vehicle control method consistent with an embodiment of the present disclosure.

FIG. 4A, FIG. 4B, and FIG. 4C are schematic diagrams showing flight routes consistent with an embodiment of the present disclosure.

FIG. 5 is a schematic diagram showing a flight range consistent with an embodiment of the present disclosure.

FIG. 6 is a schematic diagram showing a flight route consistent with an embodiment of the present disclosure.

FIG. 7 is a schematic structural diagram of a control device with an embodiment of the present disclosure.

FIG. 8 is a schematic structural diagram of a mobile platform consistent with an embodiment of the present disclosure.

### DETAILED DESCRIPTION OF THE EMBODIMENTS

The technical solution of embodiments of the present disclosure is described in detail in connection with accompanying drawings of embodiments of the present disclosure. Described embodiments are some embodiments of the present disclosure, not all embodiments. Based on embodiments of the present disclosure, all other embodiments obtained by those of ordinary skill in the art without creative effort should be within the scope of the present disclosure.

The present disclosure provides an aerial vehicle control method. The method can include generating a flight route for an aerial vehicle (such as an unmanned aerial vehicle (UAV)) according to position information of a first target, and controlling an imaging device of the aerial vehicle to always track a second target according to position information of a second target when the aerial vehicle flies according to the flight route. In some embodiments, flight control members of the aerial vehicle can cause the aerial vehicle to fly according to the flight route of the first target, and the imaging device of the aerial vehicle can track the second target to collect an image. Different components of the UAV can be decoupled from each other and operate according to different targets. Thus, the real-time automatic control ability of the aerial vehicle can be improved, and control requirements based on different targets can be satisfied in some scenarios. The automatic control process can be beneficial to reduce user manual operation processes to improve the user experience.

The control method can be applied to a control apparatus. The control apparatus can include a chip, an integrated circuit, or an electronic device with data processing functions.

If the control device is a chip or an integrated circuit with data processing functions, the control apparatus can include but is not limited to a Central Processing Unit (CPU), a Digital Signal Processor (DSP), an Application Specific Integrated Circuit (ASIC), or a Field-Programmable Gate Array (FPGA). This control apparatus can be arranged at a remote terminal or the aerial vehicle. In some embodiments, when the control apparatus is arranged at the remote terminal, the remote terminal can be communicatively connected to the aerial vehicle to control the aerial vehicle. In some embodiments, when the control apparatus is arranged at the aerial vehicle, the control device can perform the above method to control the aerial vehicle.

If the control device is an electronic device with a data processing function, the electronic device can include but is not limited to an aerial vehicle (such as a UAV), a remote terminal, or a server. In some embodiments, when the control device is the remote terminal with the data processing function, the remote terminal can be communicatively connected to the aerial vehicle to control the aerial vehicle. In some embodiments, when the control device is an aerial vehicle with the data processing function, the aerial vehicle can control itself by performing the above control method.

Embodiments consistent with the disclosure are described below using UAV as an example. Those skilled in the art, however, can understand that this disclosure is not limited to UAV. Embodiments of the present disclosure can be applied to other types of aerial vehicles or other types of vehicles, where feasible. For example, embodiments of the present disclosure can be applied to small or large UAV. The aerial vehicle can be a rotorcraft, such as a multi-rotor UAV propelled to move in the air by a plurality of propulsion devices.

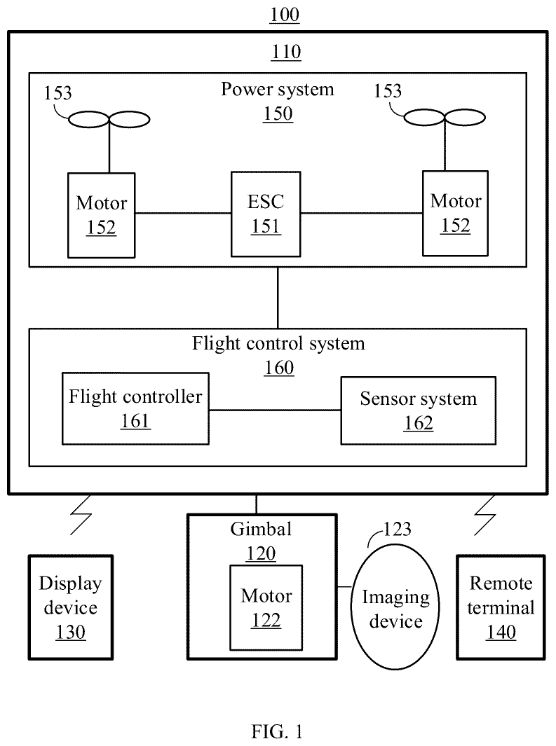

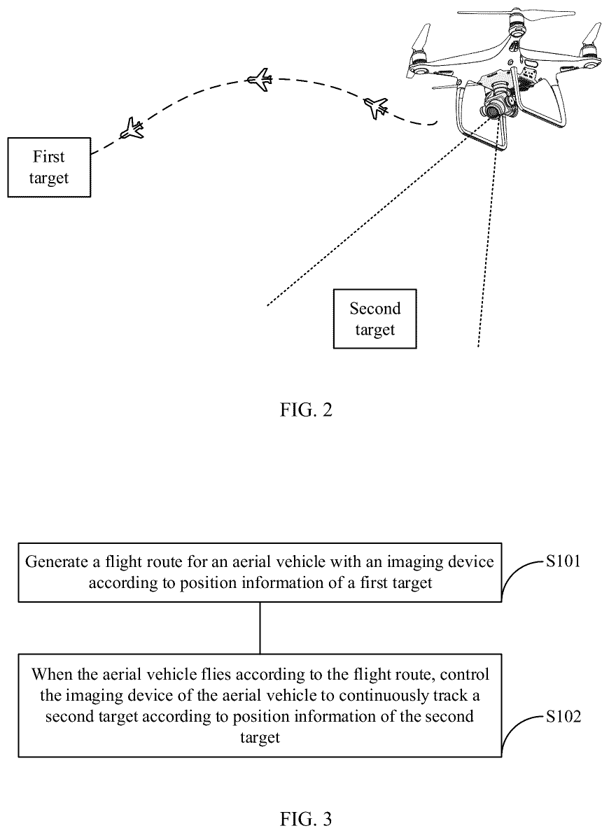

FIG. 1 is a schematic structural diagram of an aerial flight system 100 consistent with an embodiment of the present disclosure.

The UAV system 100 includes a UAV 110, a display device 130, and a remote terminal 140. A rotorcraft is shown in FIG. 1 as an example of the UAV 110, but the system 100 can include another type of UAV or another type of aerial vehicle. The UAV 110 includes a power system 150, a flight control system 160, a UAV frame, and a gimbal 120 arranged at the UAV frame. The UAV 110 can communicate with the remote terminal 140 and the display device 130 wirelessly. The UAV 110 can include an agricultural UAV or a specific application UAV, which satisfies a cyclic operation requirement.

The UAV frame can include a body and a fuselage (i.e., a landing frame). The body can include a center frame and one or more arms connected to the center frame. The one or more arms can radially extend from the center to the outside. The fuselage can be connected to the body and configured to support the UAV 110 during landing.

The power system 150 includes one or more electronic speed controllers (i.e., ESCs) 151, one or more propellers 153, and one or more motors 152 corresponding to the one or more propellers 153. A motor 152 is connected between an ESC 151 and a propeller 153. The motor 152 and the propeller 153 can be arranged at the arm of the UAV 110. The ESC 151 can be configured to receive a drive signal generated by the flight control system 160 and provide a drive current to the motor 152 according to the drive signal to control the rotation speed of the motor 152. The motor 152 can be configured to drive the propeller to rotate to provide power for the UAV 110 to fly. The power can cause the UAV 110 to realize the movement with one or more degrees of freedom. In some embodiments, the UAV 110 can rotate around one or more rotation axes. For example, the rotation axes can include a roll axis, a yaw axis, and a pitch axis. The motor 152 can include a DC motor or an AC motor. In some other embodiments, the motor 152 can include a brushless motor or a brush motor.

The flight control system 160 includes a flight controller 161 and a sensing system 162. The sensing system 162 can be configured to measure the attitude information of the UAV, i.e., the position information and status information of the UAV 110 in space, for example, a 3D position, a 3D angle, a 3D speed, a 3D acceleration, and a 3D angular speed. The sensing system 162 can include at least one of a gyroscope, an ultrasonic sensor, an electronic compass, an inertial measurement unit, a visual sensor, a global navigation satellite system (e.g., GPS), or a barometer. For example, the global navigation satellite system can be a global positioning system (GPS). The flight controller 161 can be configured to control the UAV 110 to fly. For example, the UAV 110 can be controlled to fly according to the attitude information measured by the sensing system 162. In some embodiments, the UAV 110 can be controlled by responding to one or more remote signals from the remote terminal.

The gimbal 120 includes a motor 122. The gimbal 120 can be configured to carry an imaging device 123. The flight controller 161 can control the gimbal 120 to move via the motor 122. In some embodiments, the gimbal 120 can further include a controller configured to control the gimbal 120 to move by controlling the motor 122. The gimbal 120 can be independent of the UAV 110 or be a part of the UAV 110. The motor 122 can be a DC motor or an AC motor. In addition, the motor 122 can be a brushless motor or a brush motor. The gimbal can be arranged at the top of the UAV or the bottom of the UAV.

The imaging device 123, for example, can be a camera or a recorder configured to capture an image. The imaging device 123 can communicate with the flight controller and photograph under the control of the flight controller. The imaging device 123 of embodiments of the present disclosure can at least include a photosensitive element. The photosensitive element, for example, can be a Complementary Metal Oxide Semiconductor (CMOS) sensor or a Charge-coupled Device (CCD) sensor. In some embodiments, the imaging device can be configured to capture an image or a series of images with a specific image resolution. In some embodiments, the imaging device can be configured to capture a series of images with a specific capturing rate. In some embodiments, the imaging device can include a plurality of adjustable parameters. The imaging device can capture different images with different parameters in the same external condition (e.g., the location, and the light). Thus, the imaging device 123 can be directly fixed at the UAV 110, and the imaging device 123 can be saved at the gimbal 120.

The display device 130 can be arranged at a ground terminal of the UAV flight system 100 and can communicate with the UAV 110 wirelessly and be configured to display the attitude information of the UAV 110. In addition, the image captured by the imaging device 123 can be displayed on the display device 130. The display device 130 can be an independent device or can be integrated into the remote terminal 140.

The remote terminal 140 can be located at the ground end of the UAV system, communicate wirelessly with the UAV 110, and be configured to remotely control the UAV 110.

The naming of the components of the unmanned flight system can be only for an identification purpose and should not be interpreted as limiting embodiments of the present disclosure.

In some embodiments, the control device can be arranged at the UAV. The imaging device of the UAV can transfer the image collected in real-time to the remote terminal communicatively connected to the UAV. The remote terminal can display the image collected by the imaging device. The user can select a first target and a second target from the image. The first target can be a target object or a target direction, and the second target can be the target object. The control device can be configured to obtain the first target and the second target and generate the flight route of the UAV according to the position information of the first target. For example, the flight route can be a route toward the first target. The control device can be configured to control the imaging device of the UAV to always track the second target according to the position information of the second target.

Then, a UAV control method of embodiments of the present disclosure is described. As shown in FIG. 3, embodiments of the present disclosure provide the UAV control method, which can be performed by the control device. In some embodiments, the control device can be arranged at the UAV or at the remote terminal communicatively connected to the UAV. The method includes the tracking processes.

At S101, the flight route of the UAV is generated according to the position information of the first target.

At S102, when the UAV flies along the flight route, the imaging device of the UAV is controlled to always track the second target according to the position information of the second target.

In some embodiments, the control members of the UAV can cause the UAV to fly along the flight route related to the first target, and the imaging device of the UAV can track the second target to collect the image. Thus, different members of the UAV can be decoupled and operated according to different targets, which is beneficial to improve the real-time automatic control ability of the UAV.

In some embodiments, the UAV can include a plurality of control modes, including, for example, a gesture selfie mode, an intelligent return mode, a pointing flight mode, an intelligent track mode, and a target mode of embodiments of the present disclosure.

In some embodiments, the remote terminal communicatively connected to the UAV can display the plurality of control modes. The user can select a corresponding control mode at the remote terminal as needed. For example, when the target mode is selected, the remote terminal can display the image collected by the imaging device of the UAV in real-time. The user can select the first target and the second target from the image collected by the imaging device. Thus, the control device can control the UAV to operate according to the first target and the second target selected by the user. The UAV can be configured to fly toward, away from, or around the first target in the target mode. The imaging device can be configured to track the second target in the target mode.

The representation of the target mode in the remote terminal is not limited in embodiments of the present disclosure and can be set according to actual application scenarios. For example, when the remote terminal displays the plurality of control modes, the target mode can be used as an independent mode to be displayed with other modes in parallel. When the user selects the target mode, an interaction interface related to the target mode can be displayed for the user to select the first target and the second target in the interaction interface. For example, the target mode can be one of the pointing flight mode or the intelligent track mode. The pointing flight mode can be used to indicate the flight toward the target object or in the target direction. The intelligent track mode can be used to indicate the tracking of the target object. Considering the control logic of the target mode can be partially similar to the pointing flight mode or the intelligent track mode. To facilitate the understanding of the user, the target mode can be used as a sub-mode of the pointing flight mode or the intelligent track mode. In the interaction design process, the interaction interface of the target mode can be coupled to the interaction mode of the pointing flight mode or the intelligent track mode. Thus, when the user understands the pointing flight mode or the intelligent track mode, the user can quickly understand the control process of the target mode.

In some embodiments, in the target mode, the control device can be configured to determine the first target and the second target based on different selected points in the image collected by the imaging device. The different selected points can be obtained according to different selection operations for the first target and the second target in the image of the user. The selection operation can include but is not limited to a click operation, a selection operation, or a long pressing operation.

In some embodiments, different selection operations can be used to select the first target and the second target. For example, the first target can be selected through the single click operation, and the second target can be selected through the long pressing operation. Thus, the first target and the second target can be distinguished easily.

In some embodiments, to facilitate distinguishing the first target and the second target, when the user selects the target in the target mode, e.g., in the interaction interface displaying the image collected by the imaging device in real-time, the indication information of “Please select the first target” can be displayed first. After the user selects the first target based on the indication information, the indication information of “please select the second target” can be displayed in the interaction interface displaying the image collected by the imaging device in real-time to prompt the user to select the second target. In some other embodiments, after the user selects the second target, the user can be prompted to select the first target, or after the user selects at least two targets, the user can determine at least one first target and at least one second target in the at least two targets, which are not limited here.

The first target and the second target can be selected by the user in the same image. That is, the different selection points can include different selection points obtained in the same image collected by the imaging device. In some other embodiments, the first target and the second target can be selected by the user in different images. That is, the different selection points can include the selection points obtained in the different images collected by the imaging device.

In some embodiments, considering that the first target is related to the flight of the UAV. The UAV can fly toward the target object or along the target direction. Thus, the first target can be the target object or the target direction. The user can select the first target at any position in the image collected by the imaging device. That is, the selection points used to determine the first target can be selected from any position in the image. The second target can be the object tracked and photographed by the imaging device. Thus, the second target can be the target object. The user can select the second target at the position where the object is in the image collected by the imaging device. That is, the selection points used to determine the second target can be selected from the position where the object is in the image. The target object can be a static object or a moving object, which is not limited here.

After obtaining the selection points of the image related to the first target, the control device can determine the position of the selection point related to the first target in the 3D space according to the position of the selection point of the first target in the image and through the pre-stored conversion relationship between the 2D space and the 3D space to obtain the position information of the first target. For example, the position information of the first target can include the orientation information of the first target relative to the UAV. The conversion relationship between the 2D space and the 3D space can be obtained through the internal parameter or the external parameter.

After obtaining the selection points in the image related to the second target, the control device can determine the corresponding position of the selection point related to the second target in the 3D space to obtain the position information of the second target. For example, the position information of the second target can include the orientation information of the second target relative to the imaging device. The conversion relationship between the 2D space and the 3D space can be obtained through the internal parameter and the outer parameter,

After obtaining the position information of the first target and the position information of the second target, the control device can realize the tracking scenario. When the UAV flies toward, away from, or around the first target, the imaging device of the UAV can always track the second target.

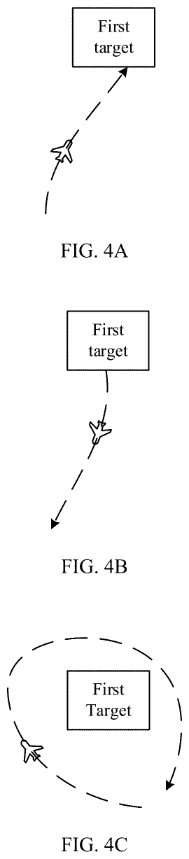

In embodiments of the present disclosure, the type of the flight route generated according to the position information of the first target is limited and can be set according to an actual application scenario. For example, the flight route can include at least one of a route toward the first target shown in FIG. 4A, a route away from the first target shown in FIG. 4B, or a route around the first target shown in FIG. 4C.

In some embodiments, the control device can generate the flight route of the UAV in connection with the position information of the UAV, the position information of the first target, and the predetermined flight route type. The position information of the UAV can be used to determine a starting trajectory point of the flight route. The position information of the first target and the predetermined flight route type can be used to determine the flight route direction and an ending trajectory point.

In some other embodiments, the control device can generate the flight route of the UAV according to the position information of the first target and the position information of the second target. In some embodiments, the flight route can be generated with reference to the position information of the second target to ensure the second target to have a good representation effect in the image collected in the imaging device when the UAV flies along the flight route.

In some embodiments, the control device can determine a flight range of the UAV according to the position information of the first target, the position information of the second target, and the position information of the UAV and generate the flight route in the flight range of the UAV. In some embodiments, determining the flight route in the flight range according to the position information of the second target can cause the second target to have a good representation effect in the image collected in the imaging device when the UAV flies according to the flight route.

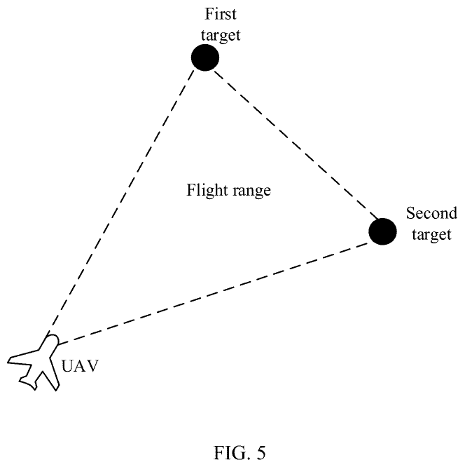

FIG. 5 shows positions of the first target, the second target, and the UAV in some embodiments. For example, the generated flight route is the route toward the first target as an example, and the control device can determine the flight range shown in FIG. 5 according to the position information of the first target, the position information of the second target, and the position information of the UAV. The position information of the UAV can be obtained according to the positioning module of the UAV. Then, the route toward the first target can be determined in the flight range. The flight range can be determined according to the position information of the second target, which is beneficial to ensure the second target to have a good representation effect in the image collected by the imaging device when the UAV flies toward the first target according to the flight route.

In some other embodiments, the control device can determine the starting trajectory point according to the position information of the UAV, determine the ending trajectory point according to the position information of the first target, and determine at least one intermediate trajectory point near the second target according to the position information of the second target. Thus, the flight route of the UAV can be generated according to the starting trajectory point, the at least one intermediate trajectory point, and the ending trajectory point. In some embodiments, the at least one intermediate trajectory point can be generated near the second target. Thus, the UAV can fly to a position near the second target when flying according to the flight route to cause the second target to have a good representation effect in the image collected by the imaging device.

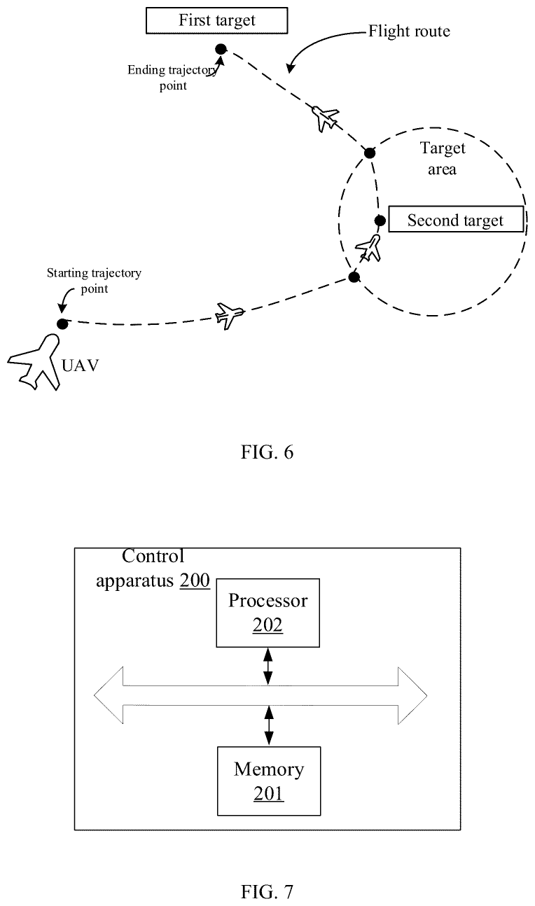

FIG. 6 shows the positions of the first target, the second target, and the UAV in an example. For example, the generated the flight route is the route toward the first target, and the control device can determine the starting trajectory point according to the position information of the UAV and determine the ending trajectory point according to the position information of the first target. In the process of generating the intermediate trajectory point, the control device can determine at least one intermediate trajectory point near the second target in a target area with the second target as a center and a determined distance as a radius. For example, three intermediate trajectory points are determined within the target area shown in FIG. 6. Thus, the control device can use the starting trajectory point, the at least one intermediate trajectory point, and the ending trajectory point to generate the flight route of the UAV shown in FIG. 6. Then, when flying according to the flight route, the UAV can fly to a position near the second target to cause the second target to have a good representation effect in the image collected by the imaging device.

To ensure that the second target is well represented in the image collected by the imaging device, the flight route of the UAV can meet the tracking conditions. When the UAV flies according to the flight route, the size of the second target in the image collected by the imaging device may not be smaller than a predetermined size to ensure an appropriate size of the second target in the image. A part of the flight route or the whole flight route can meet the above condition.

That is, to cause the second target to maintain an appropriate size in the image collected by the imaging device, the flight route can meet the tracking condition. When the UAV flies according to the flight route, the distance between the UAV and the second target may not be greater than the predetermined distance. The predetermined distance can be used to cause the second target to maintain the predetermined size in the image to ensure the second target maintain the appropriate size in the image. A part of the flight route or the whole flight route can meet the above condition.

For example, a collection range of the second target can be determined by using the second target as a center and the predetermined distance as the radius. Thus, the flight range can be determined according to the collection range and the position information of the first target, and the flight route can be generated in the flight range. The flight range can overlap with the collection range, which ensures the second target to maintain the appropriate size in the image when the UAV flies to the collection range.

For example, the starting position of the UAV in the flight route can be determined according to the predetermined distance. For example, when the distance between the UAV and the second target is greater than the predetermined distance, the UAV can be controlled to fly to a position with the predetermined distance to the second target. The position after the UAV flies can be used as the starting position in the flight route of the UAV, which ensures the second target to have the appropriate size in the image when the UAV flies.

In some embodiments, when the UAV flies according to the flight route, if an obstacle is in the flight route, the UAV may need to be controlled to avoid the obstacle. Since the imaging device needs to always track the second target, to avoid the problem of missing the second target caused by the block of the obstacle, the control device can control the UAV to fly close to on a side close to the second target to avoid the obstacle. Thus, the obstacle can be avoided, and the second target can be always in the image collected by the imaging device.

When one or more obstacles are in the flight route, the control device can determine a trajectory point at a position to avoid the obstacle on a side close to the second target and update the flight route according to the trajectory point. Thus, the control device can control the UAV to fly according to the updated flight route by avoiding the obstacle. Thus, the obstacle can be avoided, and the second target can be always in the image collected by the imaging device.

In some embodiments, the control device can generate a plurality of candidate trajectory points around the obstacle according to the position information of the obstacle. Then, the control device can determine the trajectory point on the side close to the second target from the plurality of candidate trajectory points. For example, the candidate trajectory point with the distance to the second target smaller than the predetermined threshold in the plurality of candidate trajectory points can be used as the trajectory point on the side close to the second target. Thus, the problem of missing the second target due to the blockage of the obstacle can be avoided.

In some embodiments, when the imaging device is arranged at the UAV via a gimbal, the control device can control the orientation of the gimbal according to the position information of the second target when controlling the imaging device of the UAV to always track the second target to cause the imaging device to always track the second target. For example, the position information of the second target can include the orientation information of the second target. The control device can adjust the orientation of the gimbal according to the difference between the current orientation of the gimbal and the orientation of the second target to cause the imaging device to always track the second target.

Accordingly, as shown in FIG. 7, embodiments of the present disclosure also provide a control device 200. The control device includes one or more memories 201 and one or more processors 202.

The one or more memories 201 can be used to store executable instructions.

The one or more processors 202 can be configured to, when executing the executable instructions, generate the flight route of the UAV according to the position information of the first target and control the imaging device of the UAV to always track the second target according to the position information of the second target when the UAV flies according to the flight route.

In some embodiments, the control device can be a chip, an integrated circuit, or an electronic device with data processing functions.

The one or more memories 201 can include at least one type of storage medium, including a flash memory, a hard drive, a multimedia card, a card-type memory (e.g., SD or DX memory), a random-access memory (RAM), a static random-access memory (SRAM), a read-only memory (ROM), an electrically erasable programmable read-only memory (EEPROM), a programmable read-only memory (PROM), a magnetic storage, magnetic disks, optical discs, etc. The device can also cooperate with a network storage device, which performs the storage function via network connections. The one or more memories 201 can include an internal storage unit of the device 200, such as the hard drive or memory of the device 200. The one or more memories 201 can also include an external storage device of the device 200, such as a plug-in hard drive, a Smart Media Card (SMC), a Secure Digital (SD) card, a Flash Card, etc., equipped with the device 200. Further, the one or more memories 201 can be used to store executable instructions and other programs and data required by the device. The one or more memories 201 can also be used to temporarily store the data that has been output or will be output.

Those skilled in the art can understand that FIG. 7 only shows an example of the control device 200 and does not limit the control device 200. The control device 200 can include more or fewer members, a combination of members, or different members. For example, the apparatus can further include an input/output apparatus, a network access apparatus, a bus, etc.

In some embodiments, the flight route can include at least one of a route toward the first target, a route away from the first target, or a route around the first target.

In some embodiments, the imaging device can be arranged at the drone via the gimbal.

The one or more processors 202 can be further configured to adjust the orientation of the gimbal based on the position information of the second target to cause the imaging device to continuously track the second target.

In some embodiments, the one or more processors 202 can be further configured to generate the flight route of the UAV according to the position information of the first target and the position information of the second target.

In some embodiments, the one or more processors 202 can be further configured to determine the flight range of the UAV according to the position information of the first target, the position information of the second target, and the position information of the UAV, and generate the flight route within the flight range of the UAV.

In some embodiments, the one or more processors 202 can be further configured to determine the starting trajectory point according to the position information of the UAV, determine the ending trajectory point according to the position information of the first target, and determine at least one intermediate trajectory point near the second target according to the position information of the second target. The one or more processors 202 can be further configured to use the starting trajectory point, at least one intermediate trajectory point, and the ending trajectory point to generate the flight route of the UAV.

In some embodiments, the flight route can meet the condition that the size of the second target in the image collected by the imaging device is not smaller than the predetermined size.

In some embodiments, the flight route can meet the condition that the distance between the UAV and the second target is not greater than the predetermined distance. The predetermined distance can be used to cause the second target to maintain the predetermined size in the image.

In some embodiments, the starting position of the UAV in the flight route can be determined according to the predetermined distance.

In some embodiments, the one or more processors 202 can be further configured to when the UAV flies according to the flight route, if an obstacle is in the flight route, control the UAV to fly on the side close to the second target to avoid the obstacle.

In some embodiments, the one or more processors 202 can be further configured to determine the trajectory point on the side close to the second target, update the flight route according to the trajectory point, and control the UAV to fly according to the updated flight route to avoid the obstacle.

In some embodiments, the one or more processors 202 can be further configured to generate the plurality of candidate trajectory points according to the position information of the obstacle and determine the trajectory point from the plurality of candidate trajectory points with the distance to the second target smaller than the predetermined threshold.

In some embodiments, in the target mode, the one or more processors 202 can be configured to determine the first target and the second target based on different selected points in the image collected by the imaging device.

In some embodiments, the UAV can be configured to fly toward, away from, or around the first target in the target mode, and the imaging device can be configured to track the second target.

In some embodiments, the different selected points can include selected points obtained from different images collected by the imaging device.

In some embodiments, the selected points for determining the first target can be selected from any position in the image, and/or the selected points for determining the second target can be selected from the position of the object in the image.

Since device embodiments correspond to method embodiments, for relevant parts, reference can be made to the description of the method embodiments. The implementations can be through computer software, hardware, or a combination thereof. The hardware can be implemented by at least one of a specific purpose integrated circuit (ASIC), a digital signal processor (DSP), a digital signal processing device (DSPD), a programmable logic device (PLD), a field-programmable gate array (FPGA), a processor, a controller, a microcontroller, a microprocessor, or any other electronic units configured to perform the functions described here. For software embodiments, processes or functions can be implemented by a separate software module that performs at least one function or operation. Software code can be written in any appropriate programming language, stored in memory, and executed by the controller.

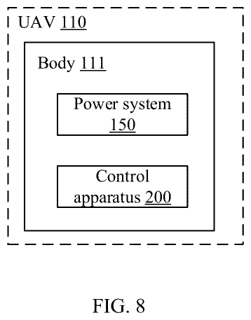

Correspondingly, if the control device is a chip or integrated circuit with the data processing function, the control device can be arranged in the UAV. FIG. 8 shows the UAV 110, the power system 150, and the control device 200. The UAV 110 includes the body 111. The power system 150 is arranged in the body 111 and configured to provide power to the UAV.

Embodiments of the present disclosure further provide a non-transitory computer-readable storage medium, including a memory storing the instructions. The instructions can be executed by the one or more processors to perform the above method. For example, the non-transitory computer-readable storage medium can include a read-only memory (ROM), a random-access memory (RAM), a CD-ROM, a tape, a floppy disk, an optical data storage device, etc.

A non-transitory computer-readable storage medium can be used to cause the terminal to perform the above method when the instructions in the storage medium are executed by the one or more processors of the terminal.

In the present disclosure, terms such as “first” and “second” are used to distinguish one entity or operation from another, but do not necessarily imply any actual relationship or order between these entities or operations. Terms such as “comprising,” “including,” or any other variations thereof are intended to encompass non-exclusive inclusion, such that a process, a method, an article, or a device that includes a series of elements can include other elements not explicitly listed, or include the elements that are inherent to the process, the method, the article, or the device. When there is no more limitation, an element defined by a phrase “including a . . .” does not exclude other same elements in the process, the method, the article, or the device that includes the element.

The method and the device of embodiments of the present disclosure are described in detail above. Embodiments are used to describe the principle and examples of the present disclosure and are merely for understanding the method and core idea. Those of ordinary skill in the art can make modifications to embodiments and application scopes according to the idea of the present disclosure. Thus, the present disclosure is not limited here.

What is claimed is:

1. A control method comprising:
generating a flight route for an aerial vehicle based on position information of a first target; and
in response to detecting a change in a relative orientation between a second target and the aerial vehicle, controlling a sensor of the aerial vehicle to continuously track the second target according to position information of the second target.

2. The method according to claim 1, wherein the flight route includes at least one of a route toward the first target, a route away from the first target, or a route around the first target; or, the target is a target object or a target direction.

3. The method according to claim 1, wherein:
the sensor is arranged at the aerial vehicle via a gimbal; and
controlling the sensor to continuously track the second target includes:
controlling an orientation of the gimbal according to the position information of the second target to cause the sensor to continuously track the second target.

4. The method according to claim 1, wherein generating the flight route includes:
generating the flight route for the aerial vehicle according to the position information of the first target and the position information of the second target.

5. The method according to claim 4, wherein generating the flight route according to the position information of the first target and the position information of the second target includes:
determining a flight range of the aerial vehicle according to the position information of the first target, the position information of the second target, and position information of the aerial vehicle; and
generating the flight route within the flight range.

6. The method according to claim 4, wherein generating the flight route according to the position information of the first target and the position information of the second target includes:
determining a starting trajectory point according to position information of the aerial vehicle;
determining an ending trajectory point according to the position information of the first target;
determining at least one intermediate trajectory point near the second target according to the position information of the second target; and
generating the flight route using the starting trajectory point, the at least one intermediate trajectory point, and the ending trajectory point.

7. The method according to claim 1, wherein generating the flight route includes generating the flight route such that a size of the second target in an image collected by the sensor is not smaller than a predetermined size.

8. The method according to claim 1, wherein generating the flight route includes generating the flight route such that a distance between the aerial vehicle and the second target is not greater than a predetermined distance.

9. The method according to claim 8, wherein a starting position of the aerial vehicle in the flight route is determined based on the predetermined distance.

10. The method according to claim 1, further comprising:
when the aerial vehicle flies according to the flight route, in response to detecting an obstacle in the flight route, controlling the aerial vehicle to fly on a side close to the second target to avoid the obstacle.

11. The method according to claim 10, wherein controlling the aerial vehicle to fly on the side close to the second target to avoid the obstacle includes:
determining a trajectory point on the side close to the second target;
updating the flight route according to the trajectory point to obtain an updated flight route; and
controlling the aerial vehicle to fly according to the updated flight route to avoid the obstacle.

12. The method according to claim 11, wherein determining the trajectory point on the side close to the second target includes:
generating a plurality of candidate trajectory points according to position information of the obstacle; and
determining a trajectory point from the plurality of candidate trajectory points with a distance to the second target being less than a predetermined threshold.

13. The method according to claim 1, further comprising:
in a target mode, determining the first target and the second target based on different selected points in an image collected by the sensor.

14. The method according to claim 13, wherein in the target mode:
the aerial vehicle is configured to fly toward, away from, or around the first target; and
the sensor is configured to track the second target.

15. The method according to claim 13, wherein the different selected points include points obtained from different images collected by the sensor.

16. The method according to claim 13, wherein:
one of the different selected points is for determining the first target and is at any position in the image; and/or
another one of the different selected points is for determining the second target and is at a position of an object in the image.

17. The method according to claim 13, wherein:
the first target includes a target object or a target direction; and
the first target is determined according to at least one or more of the selected points in the image collected by the sensor.

18. The method according to claim 17, wherein the aerial vehicle includes a pointing flight mode used to indicate a flight toward the target object or the target direction.

19. A control apparatus comprising:
one or more processors; and
one or more memories storing one or more executable instructions that, when executed by the one or more processors, cause the one or more processors to:
generate a flight route for an aerial vehicle with a sensor according to position information of a first target; and
in response to detecting a change in a relative orientation between a second target and the aerial vehicle, controlling the sensor to continuously track the second target according to position information of the second target.

20. The apparatus according to claim 19, wherein the flight route includes at least one of a route toward the first target, a route away from the first target, or a route around the first target; or, the target is a target object or a target direction.
